(19) United States
(12) Patent Application Publication
(10) Pub. No.: US 2006/0015499 A1
(43) Pub. Date: Jan. 19, 2006

(54) Method, data processing system, and computer program product for sectional access privileges of plain text files

(75) Inventors: David Neal Clissold, Austin, TX (US); Heidemarie Hoetzel, Austin, TX (US); Michael S. Lew, Austin, TX (US); Philip Kincheloe Warren, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/889,780

(22) Filed: Jul. 13, 2004

(51) Int. Cl. G06F 17/30

(52) U.S. Cl. 707/9

(57) ABSTRACT

A method, computer program product, and a data processing system for providing sectional access to a file on a per-user basis is provided. A plurality of sections of a text file are designated. A respective read access privilege attribute and a respective write access privilege attribute are associated with a user of an application program for each of the plurality of sections. A read access privilege attribute and a write access privilege attribute corresponds to one of the plurality of sections. Any of the plurality of sections to which the user has an associated read access privilege attribute that indicates the user does not have permission to read the respective section are prohibited from display in the application program.

### BACKGROUND OF THE INVENTION

1. Technical Field

The present invention relates generally to an improved data processing system and in particular to a method for providing sectional access privileges for plain text files on a per user basis. Still more particularly, the present invention provides a method for subdividing a plain text file into sections and assigning access privileges to the sections of the text file on a per user basis.

2. Description of Related Art

Conventional file permissions allow users to restrict read and write access to a file. For example, a first set of users may be granted only read access to a file and thus can only view the file, while another set of users may be granted read and write privileges to the same file and thus can modify the file in addition to viewing the file. While conventional file permissions facilitate granting of various access privileges among users, such implementations provide access privileges on a per file basis.

Some file formats, such as the Adobe Portable Document Format, implement security controls which allow certain users to have write access to a file, while restricting other users to read-only access. However, the writeable sections of an Adobe Portable Document File are presented as writeable to any user with write privileges to the file. Additionally, any user having read-access to an Adobe Portable Document File is able to view all sections of the file. That is, both read and write privileges are enforced for the entire file.

It would be advantageous to provide a mechanism for providing read and write access privileges for plain text files on a per user basis. It would be further advantageous to provide a mechanism for providing access privileges to plain text files such that a plain text file may have different access privileges assigned to users for various sections of the text file.

### SUMMARY OF THE INVENTION

The present invention provides a method, computer program product, and a data processing system for providing sectional access to a file on a per-user basis. A plurality of sections of a text file are designated. A respective read access privilege attribute and a respective write access privilege attribute are associated with a user of an application program for each of the plurality of sections. A read access privilege attribute and a write access privilege attribute corresponds to one of the plurality of sections. Any of the plurality of sections to which the user has an associated read access privilege attribute that indicates the user does not have permission to read the respective section are prohibited from display in the application program.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system that may be implemented as a client in accordance with a preferred embodiment of the present invention;

FIG. 4 is a diagrammatic illustration of a plain text file to which sectional file permissions may be granted in accordance with a preferred embodiment of the present invention;

FIG. 5 is a diagrammatic illustration of a data structure that facilitates assignment of read and write access privileges to text files on a per user basis in accordance with a preferred embodiment of the present invention;

FIG. 6 is a diagrammatic illustration of a data structure that facilities assignment of sectional access privileges to a text file on a per user basis in accordance with a preferred embodiment of the present invention;

FIG. 7 is a diagrammatic illustration of a software configuration for providing sectional access privileges to text files in accordance with a preferred embodiment of the present invention;

FIG. 8 is a flowchart illustrating processing of a text file access routine implemented according to a preferred embodiment of the present invention; and

FIG. 9 is a flowchart illustrating processing of a text file write access routine implemented according to a preferred embodiment of the present invention.

### DETAILED DESCRIPTION OF THE PREFERRED EMBODIMENT

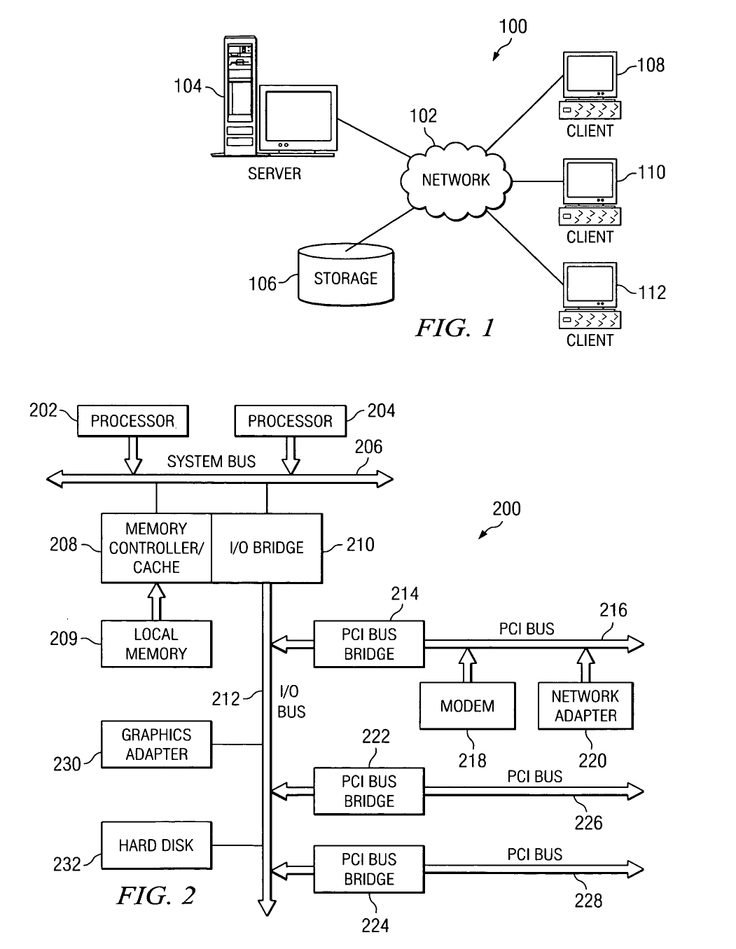

The preferred embodiment of the present invention and its advantages are best understood by referring to FIGS. 1 through 9 of the drawings, like numerals being used for like and corresponding parts of the various drawings.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pseries system, a product of International Business Machines Corporation in Armonk, N.Y., running the Advanced Interactive Executive (AIX) operating system or LINUX operating system.

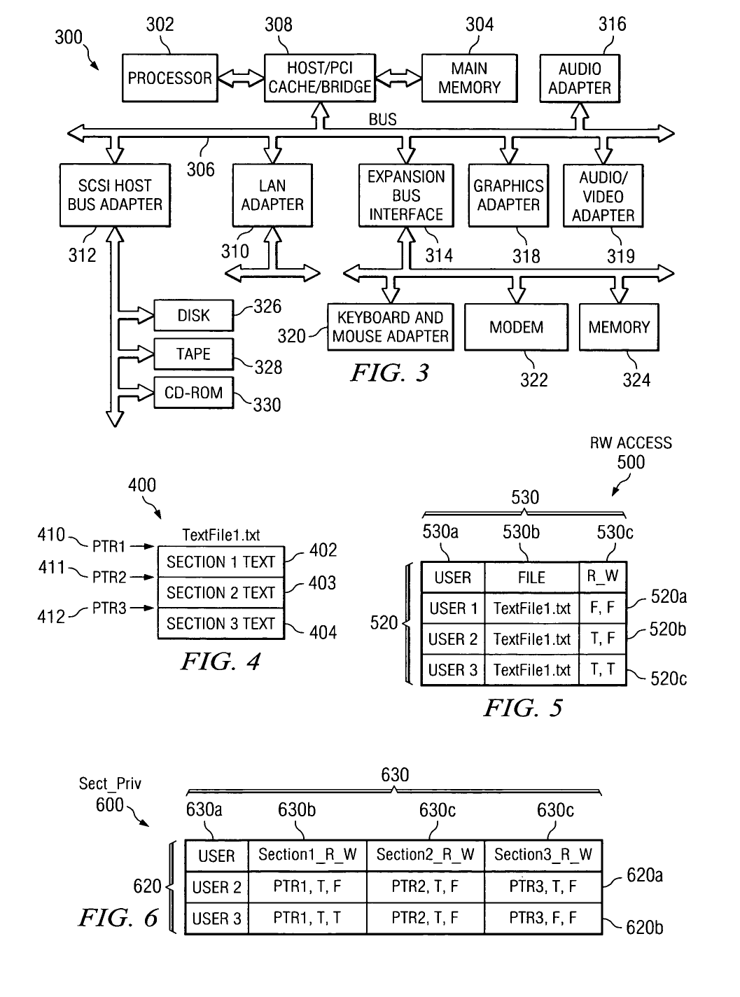

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a diagrammatic illustration of a plain text file to which sectional file permissions may be granted on a per-user basis in accordance with a preferred embodiment of the present invention. Plain text document 400 may be stored on a storage device, such as hard disk 232, loaded in a memory device, such as local memory 209, and fetched therefrom for processing by processor 202 or 204. Plain text document 400 is stored as a computer-readable data structure and includes plain text formatted data, e.g., American Standard Code for Information Interchange (ASCII) formatted text. In the illustrative example, plain text file 400 has a label, or identifier, of TextFile1.txt.

In accordance with a preferred embodiment of the present invention, sections 402-404 may have file permissions designated therefor on a per user basis. Sections 402-404 include a subset of text data of plain text file 400. For example, each of sections 402-404 may have read access or write access privileges granted to users, such as users of clients 108-112. Accordingly, a user may be granted read or write access to text file 400 while particular sections may be hidden and thus unviewable to the user while other sections are presented for viewing or modification by the user. Sections 402-404 may be addressed or identified by, for example, respective pointers 410-412, memory offsets, or another suitable addressing mechanism.

FIG. 5 is a diagrammatic illustration of a data structure that facilitates assignment of read and write access privileges of a text file on a per-user basis in accordance with a preferred embodiment of the present invention. Table 500 is an exemplary data structure that facilitates assignment of sectional read and write access privileges to a text file on a per user basis and is chosen only to facilitate an understanding of the invention, and other data structures may be suitably substituted therefor.

Table 500 comprises a plurality of records 520 and fields 530. Table 500 may be stored on hard disk 232, fetched therefrom by processor 202, and processed by data processing system 200 shown in FIG. 2. Each record 520a-520c, or row, comprises data elements in respective fields 530a-530c.

Table 500 has a label, or identifier, assigned thereto. In the present example, table 500 has a label of “RWAccess.” Fields 530a-530c have respective labels, or identifiers, that facilitates insertion, deletion, querying, or other data operations or manipulations of table 500. In the illustrative example, fields 530a-530c have respective labels of “User”, “File”, and “R_W”. A particular field, e.g., field 530a, may be designated as a key field and each respective data element is unique within key field 530a. Assignment of unique values to data elements of key field 530a provides an identifier for records 520a-520c, and the collection of data elements of key field 530a is typically referred to as an index. Addressing a particular record 520a-520c via an associated data element of key field 530a is referred to herein as indexing of record 520a-520c. Alternatively, a key may be obtained by a function, e.g., a hashing function, that indexes a particular record 520a-520c.

In the illustrative example, key field 530a has an identifier User and data elements of key field 530a comprise unique values associated with users that may access, or attempt access, to a text file. For example, data elements of key field 530a may comprise network addresses of clients 108-112 that are associated with individual users of network data processing system 100.

Field 530b contains data elements that specify a file to which user access may be granted or denied. In the illustrative example, field 530b comprises data elements of “textfile1.txt” that identify text file 400 described with reference to FIG. 4. Field 530c comprises comma separated delimiter (CSD) data elements that define read and write privilege access attributes. Each value of a CSD data element has a value of true (T) or false (F) that respectively describes a read privilege access attribute or a write privilege access attribute. Particularly, the CSD data elements of field 530c comprise a first Boolean true or false value that defines a red access privilege attribute that indicates whether the user identified in field 530a has read privileges for the text file specified in field 530b, and a second Boolean true or false value that defines a write privilege access attribute that indicates whether the user identified in field 530b has write privileges for the text file specified in field 530b.

In accordance with a preferred embodiment of the present invention, a text file access routine interrogates table 500 with a user identifier to determine if the user has read or write privileges responsive to a request by the user to view a text file, e.g., an attempt to open the text file. The user identifier may comprise, for example, an IP address of a client, such as client 108 shown in FIG. 1. If a match of the user identifier is made with a data element of field 530a, the read and write access privileges are obtained from field 530c. Additionally, in the event that table 500 is configured for access validation of more than one text file, an identifier of the text file, such as the file name or other file label, that the user has attempted to open is compared with data elements of field 530b. In the illustrative example, User1 has neither read or write access privileges to text file 400, User2 has read access privileges but does not have write access privileges to text file 400, and User3 has both read and write access privileges to text file 400.

FIG. 6 is a diagrammatic illustration of a data structure that facilitates assignment of sectional access privileges to a text file on a per user basis in accordance with a preferred embodiment of the present invention. Table 600 comprises a plurality of records 620 and fields 630. Table 600 may be stored on hard disk 232, fetched therefrom by processor 202, and processed by data processing system 200 shown in FIG. 2. Each record 620a-620b comprises data elements in respective fields 630a-630d.

Table 600 has a label of “Sect_Priv”. Fields 630a-630d have respective labels of “User”, “Section1_R_W”, Section2_R_W”, and Section3_R_W. In the illustrative example, field 630a comprises a key field of table 600 and has data elements that specify users. In the illustrative example, only users that have read access to text file 400 according to field 530c of table 500 have a corresponding entry in table 600. Thus, each of users User2 and User3 have a respective record 620a and 620b included in table 600.

Fields 630b-630d contain data elements that respectively specify user access privileges to a section of text file document 400. In the illustrative example, fields 630b-630d comprise CSD data elements with a first CSD value of each CSD data element comprising a reference or other identification of a section of text file 400. Second and third CSD values of each CSD data element comprise a Boolean value of true (T) or false (F) that respectively define read and write access privilege attributes of the text file section specified by the first CSD value of the corresponding CSD data element. For example, field 630b of record 620a has a CSD data element of “PTR1, T, F”. The first CSD value PTR1 of the CSD data element references section 402 of text file 400. The second CSD value “T” of the CSD data element indicates that the user User2 specified in field 630a of record 620a has read access privileges to section 402 specified by the first CSD value of the CDS data element. Likewise, the third CSD value “F” of the CSD data element indicates that the user User2 does not have write privileges to section 402. In a similar manner, fields 630c and 630d comprise CSD data elements that specify respective sections 403 and 404 and the read and write access privileges to be granted to the user. Thus, for example, User3 may both read and write to section 402 of text file 400 but may only read section 403 of text file 400 as the third CSD value of the CSD data element of record 620b and field 630c indicates that the user may not write to section 403. The CSD value of the CDS data element in field 630d of record 620b indicates that the user User3 may neither read nor write to section 404. Thus, section 404 will be hidden from the user User3 when viewing text file 400.

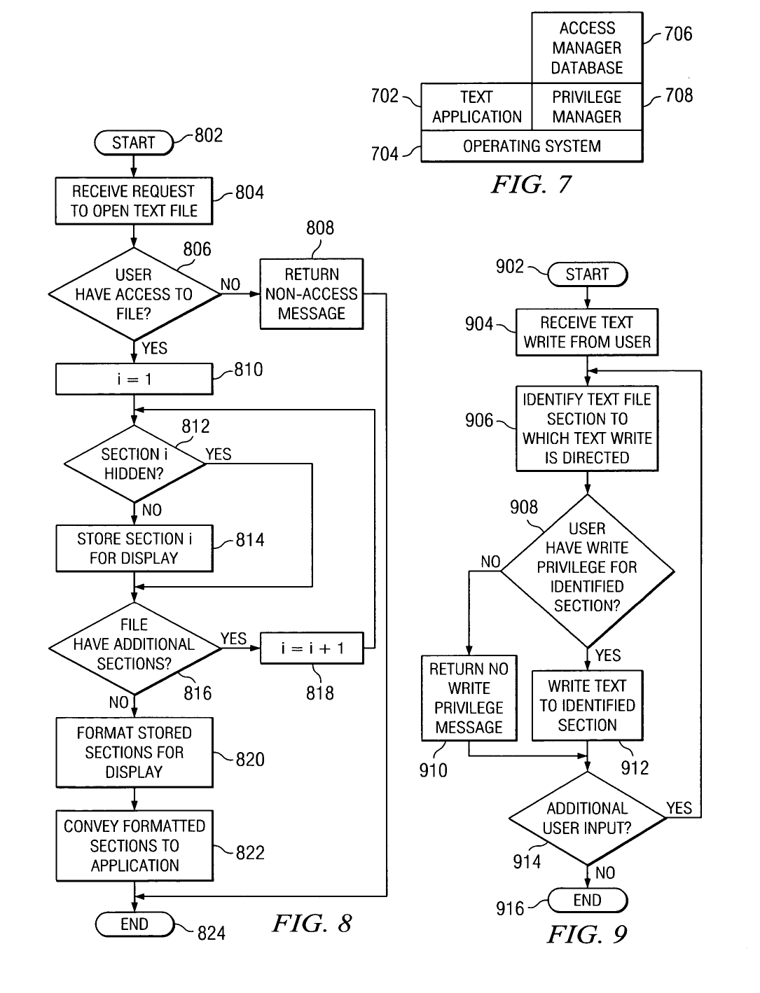

FIG. 7 is a diagrammatic illustration of a software configuration for providing sectional access privileges to text files in accordance with a preferred embodiment of the present invention. Text application program 702, such as a text file editor application or a word processing application, runs on operating system 704, such as the Unix operating system, the AIX operating system or another suitable operating system. A privilege manager application 708 may be implemented as an application program that runs on operating system 704 and interfaces with file access management database 706. File access management database 706 includes instructions that define read and write access privileges to one or more files that may be subject to access attempts by text application program 702. Particularly, file access management database 706 includes instructions that define sectional user access privileges to one or more text files on a per user basis. For example, file access management database 706 may include tables 500 and 600, or one or more suitable data structures substituted therefor, described above with reference to FIGS. 5 and 6 for defining sectional access privileges to text file 400. When text application program 702 attempts an access operation on a text file, privilege manger application 708 receives an identification associated with a user of text application program 702 and an identity of the text file that text application program 702 is attempting to access. Privilege manager application 708 then interrogates access management database 706 to determine if the user has access privileges, such as read or write privileges, for the text file.

Responsive to privilege manager application 708 verifying that the user of application 702 has an access privilege to the requested text file, additional evaluation of the user's access privileges to the requested text file is then made by privilege access manager application 708. Particularly, privilege access manager 708 identifies sections of the requested text file that have access privileges associated therewith. The user's access privileges for sections of the text file are then evaluated, and only sections to which the user has read or write privileges are conveyed to text application program 702 for display. Additionally, when text application program 702 attempts to perform a write operation to the text file responsive to a user input, the privilege access manger application 708 preferably identifies a section of the text file to which the write operation is directed and evaluates whether the user has write privileges to the identified section. The write operation is only permitted if the user has a write privilege to the identified section.

FIG. 8 is a flowchart illustrating processing of a text file access routine implemented according to a preferred embodiment of the present invention. The text file access routine may be implemented as a set of computer readable instructions, such as privilege access manager application 708 described in FIG. 7. The routine begins (step 802) and a request to open a text file is received from a text application program (step 804). The request preferably includes an identifier associated with a user, such as an IP address, a user name or the like, and an identifier of a text file, such as a text file name or label. The file access routine then evaluates whether the user has access to the requested file (step 806). In the event that the user does not have access to the requested file, a non-accessible message indicating that the user has neither read nor write privileges is returned to the text application program for display to the user (step 808), and the file access routine then ends (step 824).

If the user is determined to have access to the requested file at step 806, a counter variable i is initialized to 1 (step 810), and a section i of the requested file is evaluated to determine if it is to be hidden from the user (step 812). That is, an evaluation is made to determine if the user does not have a read access privilege to the section i. If the section i of the requested file is to be hidden, the file access routine proceeds to determine if additional sections in the text file remain for evaluation (step 816).

Returning again to step 812, if the section i of the text file is not be hidden from the user, the file access routine temporarily stores the section i (step 814) and proceeds to evaluate whether the requested text file includes additional sections for evaluation according to step 816. The file access routine proceeds to increment the counter variable i (step 818) and returns to step 812 to evaluate the next section i to determine if it is to be hidden from the user.

When all sections of the requested file have been evaluated according to step 816, the file access routine then formats the file sections stored according to step 814 for display (step 820). For example, the stored sections may be sequentially appended in order of evaluation or otherwise concatenated into a contiguous data structure. The text file sections formatted according to step 820 are then conveyed to the requesting text application program for display (step 822), and the file access routine then ends according to step 824.

FIG. 9 is a flowchart illustrating processing of a text file write access routine implemented according to a preferred embodiment of the present invention. The write access routine may be implemented as a subroutine of the text file access routine described above in FIG. 8. The write access routine begins (step 902) and receives a text write from a user (step 904). A section of the text file to which the text write is directed is identified (step 906), and an evaluation is made to determine if the user has write privileges for the identified section (step 908). In the event the user does not have write privileges for the identified section, the text-write input by the user is discarded and a no-write privilege message is returned to the text application program (step 910) for display to the user, and an evaluation is made to determine if additional user input for a write operation to the text file is to be evaluated (step 914).

Returning again to step 908, in the event that the write access routine determines that the user has a write privilege for the identified section, the input text is written to the identified section (step 912), and the write access routine proceeds to determine if additional user input for a write operation is provided according to step 914. If additional input is provided by the user for a write operation at step 914, the write access routine returns to step 906 to identify the text file section to which the text write is directed. Alternatively, the write access routine cycle ends (step 916).

Thus, a method and system for providing sectional access privileges to text files on a per user basis is provided by the present invention. Users may have read and write access privileges assigned to text files. A user having at least a read access privilege to a text file additionally has read and write access privileges defined for sections of the text file. Thus, one or more sections of a text file may be hidden from a user having read or write access privileges to the text file, and the user may be prohibited from writing to one or more text file sections that are viewable to the user.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMS, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of providing access to a file comprising the computer implemented steps of:
designating a plurality of sections of a text file;
associating a respective read access privilege attribute and a respective write access privilege attribute to a user of an application program for each of the plurality of sections, wherein both a read access privilege attribute and a write access privilege attribute correspond to one of the plurality of sections; and
prohibiting display in the application program of any of the plurality of sections to which the user has an associated read access privilege attribute that indicates permission to read the respective section is absent for the user.

2. The method of claim 1, wherein each read access privilege attribute has one of two values assigned thereto, wherein a first value indicates the user has a permission to read a section corresponding to the read access privilege attribute and a second value indicates the user does not have the permission to read the section corresponding to the read access privilege attribute.

3. The method of claim 1, wherein each write access privilege attribute has one of two values assigned thereto wherein a first value indicates the user has a permission to write to a section corresponding to the write access privilege attribute, and a second value indicates the user does not have the permission to write to the section corresponding to the write access privilege attribute

4. The method of claim 1, further comprising:
receiving a write input from the application program, wherein the write input is targeted to one of the plurality of sections; and
evaluating a write access privilege attribute of the user that corresponds to the section to which the write input is targeted.

5. The method of claim 4, further comprising:
responsive to determining that the write access privilege attribute indicates the user has write access permission to the section targeted by the write input, writing the write input to the section targeted by the write input.

6. The method of claim 4, further comprising:
responsive to determining that the write access privilege attribute indicates that the user does not have write access permission to the section targeted by the write input, discarding the write input.

7. A computer program product in a computer readable medium for providing access to a file, the computer program product comprising:
first instructions that receive a request for access to a text file;
second instructions that evaluate a plurality of read access privilege attributes each associated with a respective one of a plurality of sections of the text file; and
third instructions that format a subset of the plurality of sections for display, wherein the subset comprises each section that has an associated read access privilege attribute that indicates a user has a permission to read the associated section.

8. The computer program product of claim 7, wherein the plurality of read access privilege attributes respectively comprise one of two values, wherein a first value of the two values indicates the user has the permission to read the associated section of the plurality of sections, and a second value of the two values indicates the user does not have the permission to read the associated section of the plurality of sections.

9. The computer program product of claim 7, further comprising:
fourth instructions that evaluate a plurality of write access privilege attributes each associated with a respective one of the plurality of sections of the text file.

10. The computer program product of claim 9, wherein each of the plurality of write access privilege attributes has a corresponding read access privilege attribute.

11. The computer program product of claim 10, further comprising:
fifth instructions that receive a write request comprising a write operation targeted to one of the plurality of sections; and
sixth instructions that, responsive to receipt of the write request, evaluate one of the plurality of write access privilege attributes, wherein the one of the plurality of write access privileges is identified as the one of the plurality of sections targeted by the write operation.

12. The computer program product of claim 11, further comprising:
seventh instructions that, responsive to determining that the one of the plurality of write access privilege attributes indicates the user has a write permission to the one of the plurality of sections targeted by the write operation, execute the write operation.

13. The computer program product of claim 11, further comprising:
seventh instructions that, responsive to determining that the one of the plurality of write access privilege attributes indicates the user does not have a write permission to the one of the plurality of sections targeted by the write operation, discard the write operation.

14. The computer program product of claim 7, wherein the plurality of read access privilege attributes are maintained in a data structure with each read access privilege attribute associated with a user identifier.

15. The computer program product of claim 14, wherein the data structure further comprises a plurality of write access privilege attributes each maintained in correspondence with a one of the plurality of read access privilege attributes.

16. The computer program product of claim 15, wherein the data structure comprises a table comprising a plurality of records each having a respective identifier and one or more fields each including a one of the plurality of read access privilege attributes and a one of the plurality of write access privilege attributes.

17. The computer program product of claim 16, wherein a read access privilege attribute and a write access privilege attribute of a field respectively define a read access permission value and a write access permission value for a one of the plurality of sections for the user.

18. A data processing system for providing access to a file, comprising:
a memory that contains a read access routine as a set of instructions and a text file; and
a processing unit, responsive to execution of the set of instructions, that receives an access request for access to the text file and evaluates a plurality of read access privilege attributes each corresponding to one of a plurality of sections of the text file, wherein the processing unit excludes any of the plurality of sections for display that have a corresponding read access privilege attribute value that indicates a user does not have a read access permission for the corresponding section.

19. The data processing system of claim 18, wherein the processing unit, responsive to receipt of a write request directed to one of the plurality of sections, evaluates a write access privilege attribute associated with the one of the plurality of sections.

20. The data processing system of claim 19, wherein the write request is discarded responsive to determining that the write access privilege attribute has a value that indicates the user does not have a write access permission for the one of the plurality of sections.
